(19) United States
(12) Patent Application Publication
(10) Pub. No.: US 2016/0044876 A1
(43) Pub. Date: Feb. 18, 2016

(54) EXTRACTABLE FASTENER

(71) Applicant: Green Manufacturing, Inc., Morenci, MI (US)

(72) Inventor: Kevin J. Green, Blissfield, MI (US)

(21) Appl. No.: 14/924,804

(22) Filed: Oct. 28, 2015

Related U.S. Application Data
(63) Continuation of application No. 10/447,732, filed on May 29, 2003, now abandoned.

(51) Int. Cl. A01G 23/06

(52) U.S. Cl. CPC A01G 23/067

(57) ABSTRACT

The present invention is an extractable fastener and a method of use thereof used with a pocket or mounting block of a tool holder used to secure a cutting tooth to a cutting wheel of a stump cutting apparatus. The extractable fastener has a head portion, a shank portion having a threaded portion and an end face. The end face includes an engagement portion that receives a suitable tool whereby force applied to the tool rotates the broken portion of the fastener to remove it from the threaded bore on the pocket or mounting block.

### CROSS REFERENCE TO RELATED APPLICATIONS

This application is a Continuation of application Ser. No. 10/447,732 filed May 29, 2003, published as US Pub. No. 2004/0237749.

### BACKGROUND OF THE INVENTION

1. Field of the Invention

The present invention relates generally to a fastener used to fasten a pocket or mounting block to a cutting wheel of a stump cutting apparatus and, more specifically, to a threaded fastener having a configuration facilitating removal or extraction of a broken or sheared-off fastener from the pocket or mounting block.

2. Description of Related Art

Various types of stump cutting devices are known. A typical stump cutting apparatus includes a rotatable cutting wheel or drum having a plurality of cutting tools fastened circumferentially about the wheel or drum. Typically, a pair of pockets or mounting blocks are attached across from each other on opposite sides of the cutting wheel. One of the pockets having at least one, and preferably a pair of, counterbored apertures, extending axially through the pocket. The other pocket having at least one, and preferably a pair of, threaded apertures extending axially through the pocket.

A fastener, such as a bolt or screw, extends through the counterbored aperture in the pocket, an aperture in the cutting wheel and threadably engages the threaded aperture on the opposite pocket. Accordingly, when the fastener is tightened, it draws the pockets or tool holders together such that they sandwich the cutting wheel between them.

The loads put on the cutting tooth and corresponding pocket or mounting block during the cutting operation sometimes cause a crack or fracture in the fastener, usually at the interface between the pocket and cutting wheel. Accordingly, when trying to remove the fastener, it may completely shear off leaving a broken piece within the threaded aperture of the pocket. Additionally, high or impact loads, such as those caused by the cutting tool striking a hard object, for instance an embedded foreign object in or near the stump, may cause the fastener to break at the interface of the pocket or mounting block and cutting wheel. Again, should this happen, a portion of the threaded faster is left within the threaded aperture in the pocket or mounting block.

It is well known that removal of the sheared off bolt or threaded fastener may be extremely difficult. Accordingly, various methods and apparatuses have been developed for removing a sheared off or broken threaded fastener or bolt without destroying the tapped or threaded aperture. One approach is to drill out the broken portion, which, depending upon the skill of the individual attempting the procedure, often results in damage to the tapped or threaded aperture. In addition, a typical removal device or apparatus often threads an extractor, includes a tapered tool driven into an aperture or bore drilled into the broken portion. The extractor typically includes ridges that extend parallel to the tool shank and when driven into the broken portion, engage the broken portion. Once engaged, the extractor is then turned to rotate or back the broken portion of the fastener out of the tapped or threaded aperture. Such extractors have an inherent disadvantage, in that they exert an outward pressure against the broken fastener, which in turn is transmitted to the tapped or threaded aperture causing the mating threads to bind even more tightly.

Accordingly, there remains a need in the art for a threaded fastener which may be easily removed from the pocket or mounting block of a stump cutting tool. Such a fastener reduces downtime along with the need to discard a pocket or mounting block having a portion of a threaded fastener broken off and retained therein.

### BRIEF SUMMARY OF THE INVENTION

The present invention is an extractable threaded fastener having a head portion and a threaded portion, the end of the threaded portion having an engagement portion that receives a suitable tool which applies the necessary torque or force to remove the broken portion of the fastener.

The invention further includes the method of removing a broken fastener from the pocket or mounting block of a stump cutting tool, including the steps of using a suitable tool to engage an engagement portion on the broken fastener and applying a force necessary to remove the fastener from the pocket or mounting block.

### BRIEF DESCRIPTION OF THE SEVERAL VIEWS OF THE DRAWINGS

FIG. 1 is a schematic view of a stump cutting apparatus using an extractable fastener according to the present invention;

FIG. 2 is a cross-sectional view of the extractable fastener according to the present invention taken along lines 2-2 of FIG. 1;

FIG. 3 is a side view of the extractable fastener according to the present invention;

FIG. 4 is a front view of the extractable fastener of FIG. 3;

FIG. 5 is an end view of the extractable fastener of FIG. 3; and

FIG. 6 is a perspective view showing a suitable tool applying a necessary force to remove the fastener from the pocket or mounting block

### DETAILED DESCRIPTION OF THE INVENTION

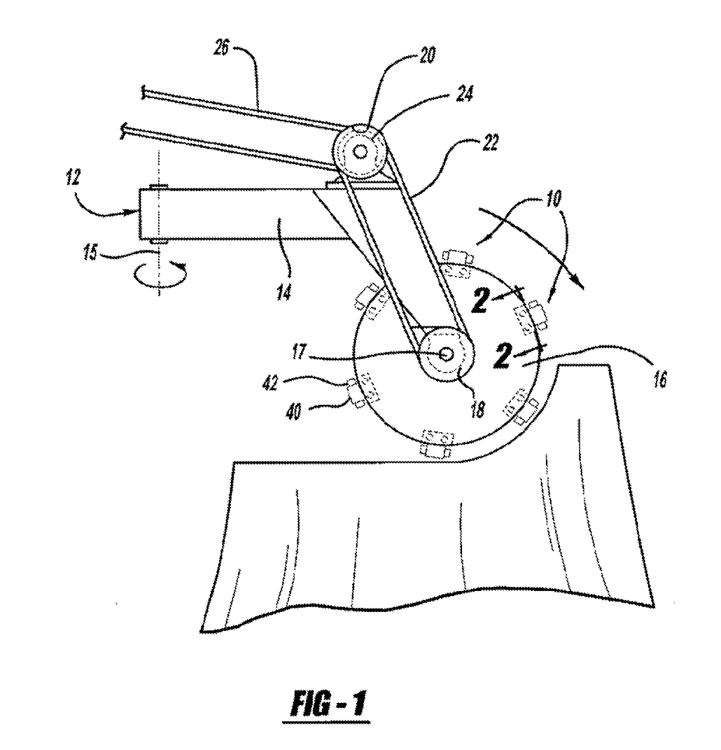

Referring now to FIG. 1, an extractable fastener 8 according to the present invention is used to fasten a stump cutting tool assembly 10 to a cutting wheel or drum 16 of a stump cutting apparatus, seen generally at 12. The stump cutting apparatus 12 includes a wheel frame 14 pivotally supported for pivotal movement about an axis 15 to a remaining portion (not shown) of the stump cutting apparatus 12.

The cutting wheel or drum 16 is rotatably mounted at the other end of the wheel frame 14 for rotational movement about an axis 17. The stump cutting apparatus 12 also includes a first pulley 18 attached to the cutting wheel or drum 16 and a second pulley 20 attached to the wheel frame 14. A belt 22 interconnects the first pulley 18 and the second pulley 20. A third pulley 24 connects to the second pulley 20 and a second belt 26 connects the third pulley 24 with a rotational source such as a motor (not shown). The rotational source rotatably moves the second belt 26 to rotate the third pulley 24 in turn, rotating the second pulley 20. Rotation of the second pulley 20 causes the first belt 22 to move, in turn rotating the first pulley 18 and correspondingly the cutting wheel or drum 16. It should be understood that a stump cutting apparatus 12 of this type is conventional and known in the art. Also, while shown herein with a cutting disk or wheel 16, the extractable fastener 8 according to the present invention may be used with a stump cutting tool assembly 10 attached to a cutting drum.

Referring now to FIGS. 2-5, an extractable fastener 8 according to the present invention for use with a cutting tool assembly 10 is shown in greater detail. Initially, it should be understood that the cutting tool assembly 10 includes a pocket or mounting block 40 and a cutting tooth 42. The pocket or mounting block 40 is typically secured to the cutting wheel 16 in pairs, wherein one of the pockets 40 includes a through bore or aperture 44 having an adjacent countersunk portion 46 and the opposite pocket having a threaded bore or aperture 48.

An extractable fastener 8 according to the present invention extends through the through bore or aperture 44, through an aperture 45 in the cutting wheel 16 and threadably engages the threaded bore or aperture 48 on the opposite or complementary pocket 40. Upon tightening the extractable fastener 8, the respective pockets 40 are drawn together and sandwich the cutting wheel 16 therebetween to secure the pockets 40 to the cutting wheel 16. Although only two extractable fasters 8 are used to secure the pockets 40 to the cutting wheel 16, additional extractable fasters 8 may also be used.

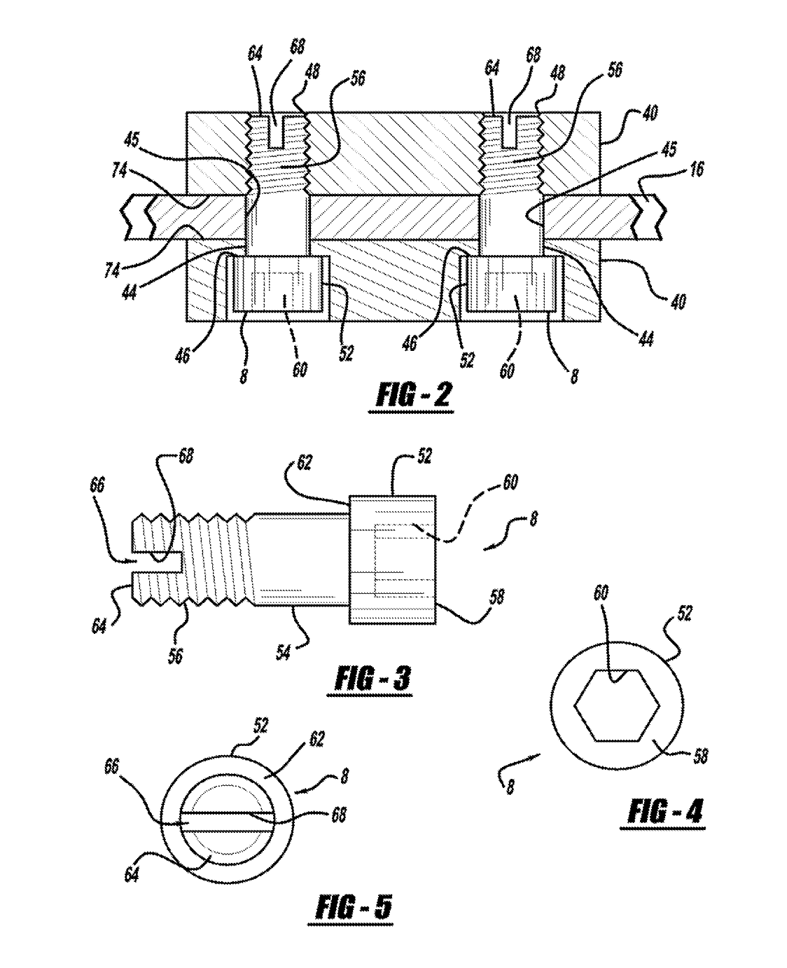

As shown in FIGS. 3-5, the extractable fastener 8 includes a head portion 52, a shank portion 54 and a plurality of threads 56 located on the shank portion 54. The end face 58 of the head portion 52 includes a hexagonal shaped socket 60 suitable for receiving a driving tool (not shown) used to rotate and correspondingly tighten the extractable fastener 8 such that when the underside or shoulder surface 62 of the head portion 52 engages the countersunk portion 46 of the pocket or mounting block 40 it drives the corresponding pocket or mounting block 40 together thereby sandwiching them on the cutting wheel 14. While the head portion 52 is shown in the present embodiment with a hexagonally shaped socket 60, this is for illustration purposes only as may other types of drive systems, such as twelve point, Torx®, square or other configurations may be used and still stay within the scope of the present invention.

As shown in FIGS. 3-5, the end face 64 of the shank portion 54 includes an engagement portion 66, shown in the preferred embodiment as a shaped recess. As shown in FIG. 3, the shaped recess is a slot 68. The engagement portion 66 may also be formed as a protrusion or projecting member, having a configuration suitable to engage a tool used to transfer torque to the fastener 8. The engagement portion 66 may be machined or formed on the end face 64.

It should be understood that the shaped recess may also be a drivingly configured socket suitable for receiving a tool that provides an amount of torque necessary to rotate or turn the fastener 8 to remove the broken portion of the fastener from the pocket 40. Examples of drivingly configured sockets include, but are not limited to hexagonal, square Phillips and Torq®, or other configuration of recesses capable of receiving a suitable tool used to apply torque to the broken fastener. As set forth above, the purpose of the shaped recess is to accept a suitable tool and transfer the torque applied by the tool to the broken portion of the fastener 8 to rotate or remove the broken portion from the pocket.

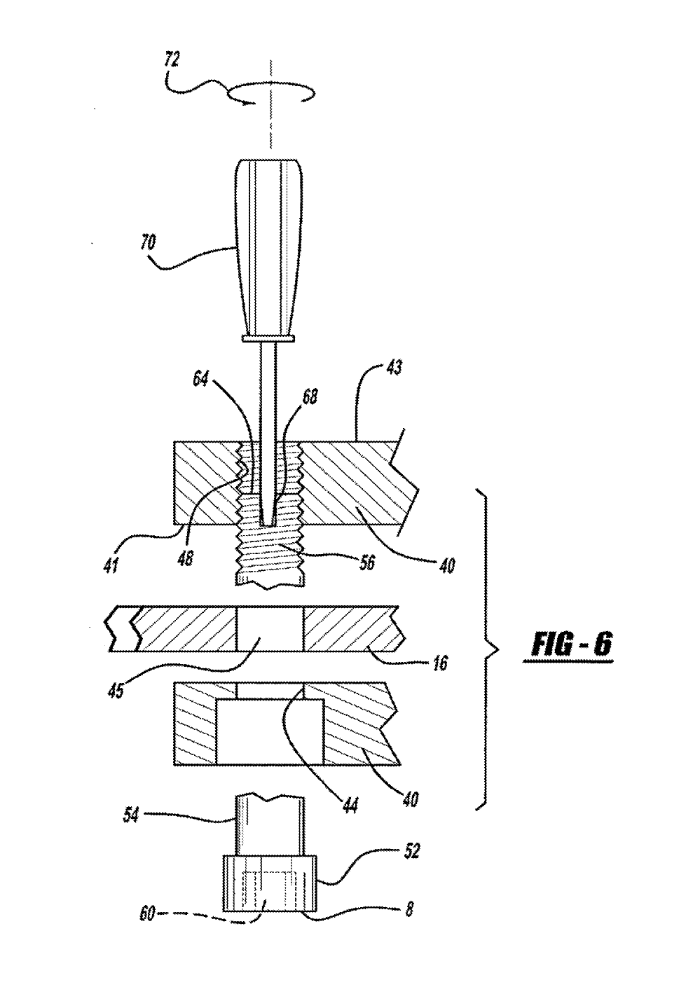

As shown in FIG. 6, the slot 68 is accessible via the threaded bore 48 when the extractable fastener 8 is tightened to secure the pocket 40 to the cutting wheel 16. Accordingly, should the extractable fastener 8 break either during the cutting operation or when attempting to remove the cutting tool assembly 10 from the cutting wheel 16, that portion of the extractable fastener 8 remaining within the pocket 40 having the threaded bore or aperture 48, may be removed by utilizing a tool 70 (see FIG. 6), having a configuration suitable for engaging the engagement portion 66. Once engaged, the tool 70 is used to correspondingly rotate and extract the broken portion of the extractable fastener 8.

FIG. 6 illustrates the method for extracting a broken extractable fastener 8 from the pocket or mounting block 40. As stated earlier, the extractable fastener 8 typically tends to crack or break at the interface 74 between the pocket or mounting block 40 and the cutting wheel 16. Should this happen, the non-threaded portion of the extractable fastener 8 may simply be removed from the aperture 45 in the cutting wheel 16 and the through bore or aperture 44 in the first pocket 40. The shank portion 54 having the plurality of threads 56 typically remains within the threaded bore or aperture 48 on the second pocket 40. In most cases, the pocket 40 is removed or taken off the cutting wheel 16 prior to removing the broken portion of the extractable fastener 8. To remove the broken portion of the extractable fastener 8, a suitable tool 70, such as a flat head screwdriver, is inserted into the slot 68 on the end face 64 of the shank portion 54. The screwdriver is used to turn the broken portion of the extractable fastener 8 in a clockwise direction 72 whereby the broken fastener is simply rotated out of the threaded bore 48 of the pocket or mounting block 40. As shown in FIG. 6, the broken portion of the extractable fastener 8 is typically rotated such that it exits on the inner side or side surface 41 of the pocket or mounting block 40 that engages the cutting wheel 16.

Normally, it is easier to rotate the broken portion of the extractable fastener 8 in a direction such that the fastener 8 exits through the inner side 41 of the pocket or mounting block 40, adjacent the cutting wheel 16. The threaded aperture of the outer or opposite side 43 of the pocket 40 can become clogged or filled with debris during the cutting operation, making it difficult to remove the broken portion of the fastener through the outer side or surface 43 of the pocket or cutting tooth 40. Although, the broken portion of the extractable fastener 8 is shown herein exiting through the inner side surface 41 of the pocket 40, it can also exit through the outer or opposite side surface 43. Accordingly, the present invention enables an operator to remove the broken portion by rotating it in either direction to cause it to exit from either the inner 41 or outer 43 side surface of the pocket 40.

Accordingly, the extractable fastener 8 of the present invention, along with the method of removing the extractable fastener 8, results in a quick and efficient way to remove a broken fastener from the threaded aperture or bore 48 of a pocket or mounting block 40.

It will thus be seen that the objects of the invention have been fully and effectively accomplished. It will be realized, however, that the foregoing specific embodiments have been shown and described for the purposes of illustrating the functional and structural principles of the invention and is subject to change without departure from such principles. Therefore, this invention includes all modifications encompassed within the scope of the following claim.

What is claimed is:

1. A cutting tool adapted for attachment near the periphery of a rotary cutting wheel of the type used in a tree stump grinding apparatus, said cutting tool comprising:
a first tool holder having a first inner side surface for directly contacting a side of the cutting wheel, said first tool holder including at least one bore extending through said first inner side surface,
a second tool holder having a second inner side surface for directly contacting a side of the cutting wheel opposite said first tool holder, said second tool holder including at least one a threaded bore extending through said second side surface and generally aligned with said bore of said first tool holder,
a fastener adapted to join said first tool holder to said second tool holder on opposite sides of the cutting wheel, said fastener having a permanent head, said permanent head including a socket configuration suitable for receiving a driving tool, said fastener having a shank extending axially from said permanent head, said shank including a terminal end opposite said permanent head, said shank including male screw threads extending from said terminal end and winding helically toward said permanent head, said male screw threads of said fastener threadably engaged within said threaded bore of said second tool holder, and
a slot disposed transversely in said terminal end of said shank and intersecting a plurality of said male screw threads, said slot extending axially toward said permanent head to form a bifurcation in said shank, said slot configured to receive the tip of a slotted screw driver when extended into said threaded bore of said second tool holder.

2. The cutting tool of claim 1, wherein said bore of said first tool holder includes a countersunk portion.

3. The cutting tool of claim 2, wherein said permanent head is registered within said countersunk portion of said first tool holder.

4. The cutting tool of claim 1, wherein said socket configuration in said permanent head comprises a hexagonal indentation.

5. The cutting tool of claim 1, wherein said shank includes a non-threaded solid portion extending between said screw threads and said permanent head.

6. A cutting tool adapted for attachment near the periphery of a rotary cutting wheel of the type used in a tree stump grinding apparatus, said cutting tool comprising:
a first tool holder having a first inner side surface for directly contacting a side of the cutting wheel, said first tool holder including at least two bores extending through said first inner side surface, each said bore of said first tool holder including a countersunk portion,
a second tool holder having a second inner side surface for directly contacting a side of the cutting wheel opposite said first tool holder, said second tool holder including at least two threaded bores extending through said second side surface, each of said threaded bores being generally aligned with a respective one of said bores of said first tool holder,
at least two fasteners, each said fastener adapted to join said first tool holder to said second tool holder on opposite sides of the cutting wheel, each said fastener having a permanent head, said permanent head including a socket configuration suitable for receiving a driving tool, said socket configuration in each said permanent head comprising a hexagonal indentation, each said permanent head registered within a respective one of said countersunk portions of said first tool holder, each said fastener having a shank extending axially from the respective said permanent head, said shank including a terminal end opposite the respective said permanent head, said shank including male screw threads extending from the respective said terminal end and winding helically toward the respective said permanent head, said male screw threads of said fastener threadably engaged within a respective one of said threaded bores of said second tool holder, each said shank including a non-threaded solid portion extending between the respective said screw threads and said permanent head, and
a slot disposed transversely in said terminal end of each said shank, said slot intersecting a plurality of the respective said male screw threads, said slot extending axially toward the respective said permanent head to form a bifurcation in said shank, each said slot configured to receive the tip of a slotted screw driver when extended into the respective said threaded bore of said second tool holder.

7. A rotary cutting wheel assembly of the type used in a tree stump grinding apparatus, said assembly comprising:
a) a rotary cutting wheel, said cutting wheel having a rotational axis, said cutting wheel having opposite sides disposed generally perpendicularly to said rotational axis, said cutting wheel having a periphery generally centered about said rotational axis, a plurality of apertures extending perpendicularly through said sides of said cutting wheel, and
b) a plurality of stump cutting tool assemblies affixed to said cutting wheel, said plurality of cutting tool assemblies generally equally spaced about said periphery of said cutting wheel, at least one of said apertures in said cutting wheel associated with a respective one of each of said stump cutting tool assemblies, wherein each said stump cutting tool assembly comprises:
1) a first tool holder having a first inner side surface for directly contacting one of said sides of said cutting wheel, said first tool holder including at least one bore extending through said first inner side surface, said bore aligned with a respective one of said apertures in said cutting wheel,
2) a second tool holder having a second inner side surface for directly contacting a side of the cutting wheel opposite said first tool holder, said second tool holder including at least one a threaded bore extending through said second side surface and generally aligned with said bore of said first tool holder and with the respective one of said apertures in said cutting wheel,
3) a fastener adapted to join said first tool holder to said second tool holder on opposite sides of said cutting wheel, said fastener having a permanent head, said permanent head including a socket configuration suitable for receiving a driving tool, said fastener having a shank extending axially from said permanent head, said shank concurrently disposed in said bore of said first tool holder and said aperture in said cutting wheel and said threaded bore of said second tool holder, said shank including a terminal end opposite said permanent head, said shank including male screw threads extending from said terminal end and winding helically toward said permanent head, said male screw threads of said fastener threadably engaged within said threaded bore of said second tool holder, and
4) a slot disposed transversely in said terminal end of said shank and intersecting a plurality of said male screw threads, said slot extending axially toward said permanent head to form a bifurcation in said shank, said slot configured to receive the tip of a slotted screw driver when extended into said threaded bore of said second tool holder.

8. The assembly of claim 7, wherein said bore of said first tool holder includes a countersunk portion.

9. The assembly of claim 8, wherein said permanent head is registered within said countersunk portion of said first tool holder.

10. The assembly of claim 7, wherein said socket configuration in said permanent head comprises a hexagonal indentation.

11. The assembly of claim 7, wherein said shank includes a non-threaded solid portion extending between said screw threads and said permanent head.

12. The assembly of claim 7, wherein said periphery of said cutting wheel is generally circular.

13. The assembly of claim 7, wherein said sides of said cutting wheel are generally flat.
